(19) United States
(12) Patent Application Publication
(10) Pub. No.: US 2025/0169505 A1
(43) Pub. Date: May 29, 2025

(54) INSECT PEST CONTROL BY A MIXTURE OF LURING SUBSTANCES WITH PATHOGENIC BIO-INSECTICIDES

(71) Applicant: GREEN PROTECTA SA, Saínt-Aubin (CH)

(72) Inventor: Mounir HASSANI, Châtel-St-Denis (CH)

(73) Assignee: GREEN PROTECTA SA, Saínt-Aubin (CH)

(21) Appl. No.: 18/834,378

(22) PCT Filed: Jan. 30, 2023
(86) PCT No.: PCT/EP2023/052188

§ 371 Date: Jul. 30, 2024

(30) Foreign Application Priority Data
Jan. 31, 2022 (EP) 22154180.8

(51) Int. Cl. A01N 63/30; A01N 25/12; A01N 31/02; A01N 31/16; A01N 35/02; A01P 7/04; A01P 19/00

(52) U.S. Cl. CPC A01N 63/30; A01N 25/12; A01N 31/02; A01N 31/16; A01N 35/02; A01P 7/04; A01P 19/00

(57) ABSTRACT

A formulation containing an attractant specific for a targeted pest insect and an entomopathogenic bio-insecticide to control pest insect populations. By attracting the insect pest into a trapping device, loading it with the formulation and then, at exiting the trapping device, the insect will disseminate in the field where it will eventually die. Wherever some formulated material will have been distributed in the field, further fellow creatures of the same species will be attracted and infected, thus multiplying the effect of the primary trapping device. The pest insect is used as the vector of its own demise, effectively using a minimal amount and limited applications of pesticides of biological origin.

### FIELD OF THE INVENTION

The invention relates to the field of biological insect pest control, in particular the use of a preparation composed of semiochemical products and an entomopathogenic fungus placed in a device suitable for controlling populations of thrips and other insects in agriculture and horticulture.

### BACKGROUND OF THE INVENTION

The western flower thrips, Frankliniella occidentalis (Pergande) (Thysanoptera: Thripidae) (abbreviated as WFT) is one of the most significant agricultural pests globally, because of the damage it is able to inflict to agricultural crops such as beans, pepper (capsicum), cucumber, eggplant, lettuce, onion, tomatoes, strawberries or melons, and to ornamentals crops, such as carnation, chrysanthemum, orchids, rose and tuberose, with yield losses reaching up to 50%. WFT are also the vector of several species of damaging plant viruses in the genus Tospovirus (Bunyaviridae), including tomato spotted wilt virus (TSWV) and impatiens necrotic spot virus (INSV), affecting both the quantity and quality of plant products with over 90% yield loss in some instances. In 2018, these crops were harvested over more than 55 million hectares in the World (FAOSTAT).

Western flower thrips management in greenhouses is complex due to high female reproductive capacity, its rapid life cycle, its small size, and its feeding habits. Insecticide resistance has developed over time. The current strategies effectively dealing with WFT in greenhouse production systems consists in scouting for population development and combining cultural, biological management and insecticide applications (Cloyd, Raymond A. 2019. “Effects of Predators on the Belowground Life Stages (Prepupae and Pupae) of the Western Flower Thrips, Frankliniella Occidentalis (Thripidae: Thysanoptera): A Review.” Advances in Entomology 07 (04). Scientific Research Publishing, Inc,: 71-80. doi: 10.4236/ae.2019.74006.).

Chemical insectcides, of synthetic origine as methomyl or dinotefuranor, or of natural origin such as spinosad or abamectin, are used to control thrips in the field. However, contact insecticides generally do not reach where the thrips are located on the plant, and systemic insecticides do not act rapidly enough to prevent virus transmission. Growers often repeatedly apply several groups of insecticides to control thrips and similar pests. However, because of its cryptic behaviour and because most of the thrips pupate in the soil, they are not easily controlled with chemical pesticides (Berndt, Oliver, Rainer Meyhöfer, and Hans-Michael Poehling. n.d. “The Edaphic Phase in the Ontogenesis of Frankliniella Occidentalis and Comparison of Hypoaspis Miles and Hypoaspis Aculeifer as Predators of Soil-Dwelling Thrips Stages.” https://doi.org/10.1016/j.biocontrol.2003.09.009). Moreover, due to the repeated and frequent application of insecticides, thrips have developed resistance to a wide variety of pest-control products (Broadbent, A.B., and D.J. Pree. 1997. “Resistance to Insecticides in Populations of Frankliniella Occidentalis (Pergande) (Thysanoptera: Thripidae) from Greenhouses in the Niagara Region of Ontario.” Canadian Entomologist 129 (5): 907-13. https://doi.org/10.4039/ent129907-5).

As an alternatice to chemical control, predatory insects are used in covered crops, predacious anthocorids (Orius spp.) or mirids (Macrolophus caliginosus), predacious mites (Amblyseius genus), or the predatory nematodes Steinernema carpocapsae and Heterorhabditis heliothedis against the pupae in the soil. Three species of entomopathogenic biopesticides are available on the market, made of spores or conidiaie of active strains of Metarhizium anisopliae, Beauveria bassiana, and Paecilomyces fumosoroseus. The potential of these fungi to control soil-dwelling stages of WFT was evaluated in various growing media. Two Metarhizium anisopliae (Metsch) Sorokin strains, V275 and ERL700, were the most effective, causing 85-96% mortality of thrips larvae and pupae (as measured by relative adult emer-gence rates), 11 days after inoculation. Mortality in other M. anisopliae-treated media ranged from 51-84%; Beauveria bassiana (Balsamo) Vuillemin strains caused 54-84% mortality, and Paecilomyces fumosoroseus (Wize) 63-75% mortality (Ansari, M.A., M. Brownbridge, F.A. Shah, and T.M. Butt. 2008. “Efficacy of Entomopathogenic Fungi against Soil-Dwelling Life Stages of Western Flower Thrips, Frankliniella Occidentalis, in Plant-Growing Media.” Entomologia Experimentalis et Applicata 127 (2): 80-87. https://doi.org/10.1111/j.1570-7458.2008.00674.x.). To be effective, the biological control of WTF and other species must be repeated frequently and, therefore, entails high costs.

The use of a combination of pheromones or kairomone to target better the pest insect with a biopesticide has so far not be proven effective. Trials have shown that treatments with Beauveria bassiana associated with attractants did not reduce thrips populations more than tretaments with Beauveria bassiana alone (Ludwig, Scott W., and Ronald D. Oetting. 2002. “Efficacy of Beauveria Bassiana Plus Insect Attractants for Enhanced Control of Frankliniella Occidentalis (Thysanoptera: Thripidae).” Florida Entomologist 85 (1): 270-72. https://doi.org/10.1653/0015-4040 (2002) 085 [0270: eobbpi] 2.0.co;2) . . .

In experiments concerning another insect specie, Drosophila suzukii, and another entomopathogneous fungus, Metarhizium brunneum, the mortality using a combination of the biopesticide with a feeding attractant (kairomone) reached a rate of 61.6%, in comparison with a mortality rate of 50.0% when using the biopesticide alone.

Some literature and patent documents describing the concept of luring the pest insect and load it with a dosis of a pesticide that, before dying itself will disseminate in the near environment to infect its fellow creatures.

Robert Koller et al. (Insect Pathogens and Insect Parasitic Nematodes: Melolontha, IOBC/wprs Bulletin Vol. 28(2), 2005, pp. 37-44. Biocontrol of the forest cockchafer (Melolontha hippocastani): Experiments on the applicability of the “Catch and Infect”-Technique using a combination of attractant traps with the entomopathogenic fungus Beauveria brongniartii) have made experiments consisting in pre-infecting males of the forest cockchafer, Melolontha hippocastani, by artificially spraying them with spores of the entomopathogenic fungus Beauveria brongniartii. These contaminated insects were then released in cages where they were attracted into traps baited with a mixture of the sexual pheromone 1,4-benzoquinone and the sexual kairomone (Z)-3-hexen-1-ol. It was shown that the previously contaminated male cockchafers could transfer spores of the mycoinsecticide to females and other not previously contaminated males that had also been attracted into to trap. However, no natural mechanism to infect the primary male insects and to disseminate the insectice in the crop environment was described.

F. Nchu et al.in “The use of a semiochemical bait to enhance exposure of Amblyomma variegatum (Acari: Ixodidae) to Metarhizium anisopliae (Ascomycota: Hypocreales), Veterinary Parasitology 160 (2009) 279-284 describe one of the usual “attract and kill” system in which the bait consists in a formulated mixture (powder or oily emulsion) of semiochemicals with spores of an entomopathogenic fungus to which the tropical bont tick Amblyomma variegatum will be attracted and with which it will be contaminated. However, such infested arachnides are not used to disseminate further the pest control mechanism in the environment. Furthermore, this document does not deal with insects but arachnides only.

In GB 2419531 A, David William Hartley and Alan Roy Davies disclose a method of controlling insect pests in an arboreal crop such as an orchard comprising the steps of: arranging a pathogen source proximate to a lure; attracting the insect pests to the lure so that they acquire and carry pathogen from the source; and allowing the pathogen-carrying insects to move away from the lure into the population of the insect pests in the orchard, whereby the pathogen is transferred to that population. Traps for carrying out the method are also described. The lure may comprise a semiochemical such as a pheromone. The method is effective against codling moth (Cydia pomonella) infestation. The pathogen may be a fungus such as Beauveria bassiana, Metarhizium anisopliae or Paecilomyces fumosoroseus.

In U.S. Pat. No. 5,057,315 A, Fernando Agudelo-Silva et al, describe a convenient, economical, non-toxic and effective method and means for the control of roaches by administration of entomopathogenic fungi to the cockroaches. In the preferred embodiment, the roaches are exposed to the fungi by means of a contamination chamber having openings through which the cockroaches enter and come in contact with a living culture of a fungus which is pathogenic to cockroaches. The fungal spores attach to the roach, germinate and penetrate into the body of the cockroach, resulting in the death of the infected roach. Death takes approximately two to three weeks after contact with the culture. During this time, the infected roach disseminates spores of the pathogenic fungus throughout the infested areas which may subsequently infect other roaches. Given the proper environmental conditions, the fungus sporulated on the cadaver of the roach and the conidia can be transmitted to other cockroaches, resulting in a further spread of the disease.

In WO 2008/095016 A2, Kenneth J Kupfer and Robert E. McManus disclose a composition of insect attractants in dry powdery formulations that when mixed with or used in cooperation with pre-registered, commercially-available, active ingredients and solvents, form low-toxicity, environment-friendly, baiting systems to attract and kill or otherwise neutralize a broad range of crop-damaging, crawling, walking and flying insects.

In WO 2013/134870 A1, Todd Gordon Mason and John Clifford Sutton. disclose a powder plant treatment formulation for application to plants by bee vectoring comprising a particulate calcium silicate, clonostachys rosea, a moisture absorption agent for absorbing moisture from the formulation, an attracting agent for attracting the formulation to plants and a diluent.

In WO 2012/135940 A1, Michael Howard D Hearn Collinson et al. disclose an apparatus for beehives with which bees will be loaded plant treatment agents and disseminated in the environment by bees and humblebees.

In the latter, bees or bumblebees are supposed to be the vector of a mixture of attractants with a pesticidal substance. This will require the prior introduction of bumblebees into the field to be treated.

Thus, there is still a need to provide an effective pest insect control formulation for controlling populations of thrips and other insects in agriculture and horticulture using minimal amounts of pesticides of biological origin.

### BRIEF DESCRIPTION OF THE INVENTION

The main differences with the present invention and the prior art are as follows, either the mixture that an insect carries away after exiting the trapping device does not contain an attractant (pheromone or kairomone) which is one of the embodiments of the present invention, or the insects that will disseminate and contaminate congeners have been artificially pre-infected with a bioinsecticide, or no dissemination step is included in the system of the prior art.

The major embodiment of the invention consists in a pest insect control formulation or mixture that contains an attractant and a biopesticide based on entomopathogenic fungus that specifically attracts and infects a pest insect in a multistep process. The process is summarized as follows: (1) attract a first pest insect specimen (ATTRACT 1), (2) load it with the pest insect control formulation of the invention (CONTAMINATE), (3) have the insect disseminate the mixture in the near environment (DISSEMINATE), in order to, (4) attract further pest insects of the same species wherever the mixture or formulation will have been deposited by the first specimen (ATTRACT 2), e.g. on the plant, on the ground, or on the body of already dead insects (KILL 1), (5) let them infect themselves with the bio-pesticide (CONTAMINATE 2), and finally (6) allowing the toxic action of the biopesticide to take effect (KILL 2). An appropriate formulation of the mixture is in the form of a powder, including inert components, and an adequate trapping device will ensure that the first three steps are effectively carried out.

In particular, one object of the invention concerns a pest insect control formulation in the form of a powder comprising or consisting in the mixture of at least one pheromone and at least one kairomone as the pest insect attractant and at least one bio-insecticide acting by contact consisting of entomopathogenic fungus, said mixture being combined with at least one convenient inert carrier which has the property to allow said pest insect control formulation to adhere to the pest insect body and which is selected from the group consisting of kaolin, talc, bentonite, calcite, attapulgite, silica, aerosil, starch, stearic acid and stearates, corn flour, wheat flour, sugars such as fructose and glucose, or mixtures thereof, wherein said at least one pheromone, kairomone and bio-insecticide acting by contact is specific to said pest insect and wherein said pest insect species are selected from the group of insect orders consisting of Diptera, Homoptera, and Thysanoptera (Thripidae) such as Frankliniella occidentalis (western flower thrips) or Hemiptera from the Aleyrodidae family (whiteflies family).

Another object of the invention concerns a pest insect control method comprising or consisting in the steps of:
a) attracting a pest insect in a trapping device containing the pest insect control formulation according to the invention;
b) contaminating said pest insect with said pest insect control formulation according to the invention;
c) disseminating said contaminated pest insect into the field environment;
d) said disseminated and contaminated pest insect further attracting and contaminating other non-infected pest insects of the same species, wherein said pest insect species are selected from the group of insect orders consisting of Diptera; Homoptera and Thysanoptera (Thripidae) such as Frankliniella occidentalis (western flower thrips) or Hemiptera from the Aleyrodidae family (whiteflies family).

Other objects and advantages of the invention will become apparent to those skilled in the art from a review of the ensuing detailed description, which proceeds with reference to the following illustrative drawings, and the attendant claims.

### BRIEF DESCRIPTION OF THE FIGURE

FIG. 1: illustrates a schematic picture of the insect control process according to the invention as explained above. The schematic representation of the invention is as follows: (1) attract a first pest insect specimen (ATTRACT 1), (2) load it with pest insect control formulation (CONTAMINATE), (3) have the insect disseminate the mixture in the near environment (DISSEMINATE), in order to, (4) attract further pest insects wherever the mixture will have been deposited by the first specimen (ATTRACT 2), e.g. on the plant, on the ground, or on the body of already dead insects (KILL 1), (5) let them infect themselves with the biopesticide (CONTAMINATE 2), and finally (6) allow the toxic action of the pesticide to take effect (KILL 2).

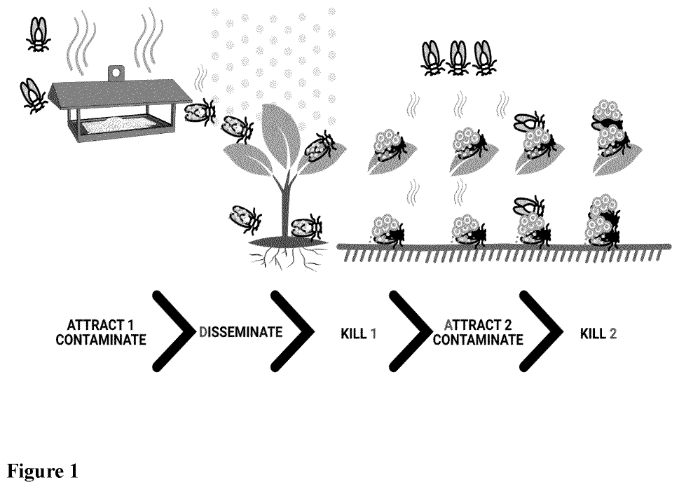

### DETAILED DESCRIPTION OF THE INVENTION

The present invention offers innovative and biological approaches to controlling pests in horticulture, agriculture and forestry, including an original method to control for example thrips (Frankliniella occidentalis) in their first stage. This method is particularly useful to treat high value greenhouse vegetable crops such as cucurbits, tomato, pepper, eggplant, as well as strawberries and ornamentals such as roses, chrysanthemum, gerbera.

The invention also provides for a method of attracting the pest, infecting it with an insecticidal microorganism and letting it attract and infect other individuals of the same population in the field or greenhouse. With this original method, the targeted harmful insect is used as the executioner of its congeners.

It is an attractive alternative to spraying common insecticides and more effective than other biological solutions on the market. Risks are thus practically eliminated concerning the health of the farmer and consumers as well as the environment. Other insect species, such as whiteflies which are virus vectors, are also the subject of similar methods.

Although methods and materials similar or equivalent to those described herein can be used in the practice or testing of the present invention, suitable methods and materials are described below. All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control.

Unless defined otherwise, all technical and scientific terms used herein have the same meaning as is commonly understood by one of skill in art to which the subject matter herein belongs. As used herein, the following definitions are supplied in order to facilitate the understanding of the present invention.

The term “comprise” is generally used in the sense of include, that is to say permitting the presence of one or more features or components.

The terms “consisting in” or “consisting of” is a transitional phrase that limits the scope of a claim to the specified materials or steps and those that do not materially affect the basic and novel characteristics of the claimed invention.

As used in the specification and claims, the singular forms “a”, “an” and “the” include plural references unless the context clearly dictates otherwise.

A “semiochemical” is a pheromone or other chemical that conveys a signal from one organism to another so as to modify the behaviour of the recipient organism.

A “pheromone” is a secreted or excreted chemical factor that triggers a social response in members of the same species. Pheromones are chemicals capable of acting like hormones outside the body of the secreting individual, to impact the behavior of the receiving individuals. There are alarm pheromones, food trail pheromones, sex pheromones, and many others that affect behavior or physiology. Pheromones are used from basic unicellular prokaryotes to complex multicellular eukaryotes. Their use among insects has been particularly well documented.

A “kairomone” is a semiochemical, emitted by an organism, which mediates interspecific interactions in a way that benefits an individual of another species which receives it and harms the emitter. This “eavesdropping” is often disadvantageous to the producer (though other benefits of producing the substance may outweigh this cost, hence its persistence over evolutionary time). The kairomone improves the fitness of the recipient and in this respect differs from an allomone (which is the opposite: it benefits the producer and harms the receiver) and a synerone (which benefits both parties). The term is mostly used in the field of entomology (the study of insects). Two main ecological cues are provided by kairomones; they generally either indicate a food source for the receiver, or the presence of a predator, the latter of which is less common or at least less studied.

The term “attracting activity” as used herein means an effect similar to the effect that a female of a pest insect has for attracting conspecific males.

A bio insecticide is a biopesticide having specific activity against one or more insects. In particular, it refers to an insect-control measure of biological origin, especially an insecticidal microorganism or natural toxin acting by contact.

An “entomopathogenic fungus” is a fungus that can act as a parasite of insects and kills or seriously disables them. These fungi usually attach to the external body surface of insects in the form of microscopic spores (usually asexual, mitosporic spores also called conidia). Under the right conditions of temperature and (usually high) humidity, these spores germinate, grow as hyphae and colonize the insect's cuticle; which they bore through by way of enzymatic hydrolysis, reaching the insects' body cavity (hemocoel). Then, the fungal cells proliferate in the host body cavity, usually as walled hyphae or in the form of wall-less protoplasts (depending on the fungus involved). After some time the insect is usually killed (sometimes by fungal toxins), and new propagules (spores) are formed in or on the insect if environmental conditions are again right. High humidity is usually required for sporulation.

The expression “attract and kill” refers to luring pest insects with semiochemicals into biting into, or have their bodies contaminated by, a bait containing an insecticide. There is attraction of the pest insect, for example in a trap whose exit is closed, then direct and immediate destruction of the pest insect by the insecticide and therefore no propagation of the latter.

It is one object of the invention to provide a pest insect control formulation in the form of a powder comprising or consisting in the mixture of at least one pheromone and at least one kairomone as the pest insect attractant and at least one bio-insecticide acting by contact consisting of entomopathogenic fungus, said mixture being combined with at least one convenient inert carrier which has the property to allow said pest insect control formulation to adhere to the pest insect body and which is selected from the group consisting of kaolin, talc, bentonite, calcite, attapulgite, silica, aerosil, starch, stearic acid and stearates, corn flour, wheat flour, sugars such as fructose and glucose, or mixtures thereof, wherein said at least one pheromone, kairomone and bio-insecticide acting by contact is specific to said pest insect and wherein said pest insect species are selected from the group of insect orders consisting of Diptera, Homoptera, and Thysanoptera (Thripidae) such as Frankliniella occidentalis, (western flower thrips) or Hemiptera from the Aleyrodidae family (whiteflies family).

Preferably, the pest insect species are insects selected from the group of insect orders comprising or consisting of Diptera such as the suzuki-fruit fly (Drosophila suzukii), Thysanoptera (Thripidae) such as Frankliniella occidentalis, (western flower thrips) or Hemiptera from the Aleyrodidae family (whiteflies family) such as the Bemisia tabaci and Trialeurodes vaporariorum species.

According to one embodiment, said at least one pheromone is selected from the group consisting of Neryl-(S)-2-methylbutyrate; (S)-(Z)-3,7-Dimethyl-2,6-octadienyl-2-methylbutanoate; Neryl(S)-2-methylbutanoate; (R)-5-Methyl-2-(prop-1-en-2-yl)-hex-4-enyl acetate; (R)-lavandulyl acetate; 1,6,10-Dodecatriene, 7,11-dimethyl-3-methylene; (E)-beta-farnesene; 1,7-dioxaspiro (5.5) undecane; 1,5,7-Trioxaspiro[5.5]undecane; 9-tricosene; (-)-8-Heptalactone; dihydro-beta-ionone; Methyl anthranilate; Cis-jasmone; Trans caryophyllene or mixtures thereof.

According to another embodiment, said at least one kairomone is selected from the group consisting of Ethyl nicotinate; p-anisaldehyde; ethyl isonicotinate; (Z)-3-hexen-1-ol; α-pinene; (E)-β-caryophyllene; α-humulene; azulene; Trimedlure; methyl eugenol; Terpinyl acetate; acetate; Ginger Oil or mixtures thereof.

TABLE 1

| Order | Pheromone | Kairomone |
|---|---|---|
| Diptera: (such | 1,7 Dioxaspiro[5.5] undecane; | Methyl eugenol; |
| as Olive fly | (−)-δ-Heptalactone; | Trimedlure; |
| and fruit fly) | 1,5,7- | Terpinyl acetate; |
| | Trioxaspiro[5.5]undecane; | Ammonium |
| | (Z)-9-tricosene | bicarbonate/ammonium |
| | | acetate; |
| | | Ginger Oil |
| Homoptera and | (S)-(Z)-3,7-Dimethyl-2,6- | Ethyl nicotinate, |
| Thysanoptera | octadienyl 2-methylbutanoate; | p-anisaldehyde, |
| | Neryl-(S)-2-methylbutyrate; | ethyl isonicotinate |
| | Neryl (S)-2-methylbutanoate; | |
| | (R)-5-Methyl-2-(prop-1-en-2- | |
| | yl)-hex-4-enyl acetate; | |
| | Methyl anthranilate; | |
| | Cis-jasmone; | |
| | Trans caryophyllene | |
| Aleyrodidae | Dihydro-beta-ionone | (E)-2-Hexanal; |
| (Hemiptera) | | (E)-2-Hexen-1-ol; |
| | | (E)-β-caryophyllene; |
| | | α-humulene; |
| | | azulene |
| | | (see CN111387187 A |
| | | INST PLANT PROT |
| | | CAAS) |

A list of the main pheromones and kairomones that are specific to the pest insects selected from the group of insect orders consisting of Diptera such as Olive fly and fruit fly, Homoptera and Thysanoptera (Thripidae) such as Frankliniella occidentalis (western flower thrips) or Hemiptera from the Aleyrodidae family (whiteflies family) such as Bemisia tabaci and Trialeurodes vaporariorum are summarized in Table 1.

According to yet another embodiment, said at least one bio-insecticide acting by contact consists of entomopathogenic fungus which are selected from the group consisting of the strains of Metarhizium anisopliae, Verticillium lecanii, Beauveria bassiana, Metarhizium brunneum, Isaria fumosorosea, Paecilomyces fumosoreuses, Beauveria brongniatii, or mixtures thereof.

According to a particular embodiment, said at least one pheromone is Neryl-(S)-2-methylbutyrate, said at least one kairomone is p-anisaldehyde or Ethyl nicotinate or a mixture thereof and said at least one bio-insecticide acting by contact is selected from the group consisting of Metarhizium anisopliae, Verticillium lecanii, Paecilomyces fumosoreuses, Beauveria bassiana, or a mixture thereof and wherein said pest insect is the western flower thrips (Frankliniella occidentalis).

According to another particular embodiment, said at least one pheromone is dihydro-beta-ionone, said at least one kairomone is (E)-2-Hexanal or (E)-2-Hexen-1-ol or a mixture thereof and said at least one bio-insecticide acting by contact is selected from the group consisting of Metarhizium anisopliae, Verticillium lecanii, Beauveria bassiana, or a mixture thereof and wherein said pest insect is the whitefly selected from the species consisting in Bemisia tabaci and Trialeurodes vaporariorum.

According to yet another embodiment, the pest insect control formulation comprises at least one pheromone which is Z)-9-tricosene, the at least one kairomone is methyl eugenol and the at least one bio-insecticide acting by contact is Beauveria bassiana, and wherein the pest insect is the Drosophila suzukii.

In particular, the invention provides for a pest insect control formulation in the form of a powder comprising or consisting in:
at least one pheromone selected from the group consisting of Neryl-(S)-2-methylbutyrate; (S)-(Z)-3,7-Dimethyl-2,6-octadienyl-2-methylbutanoate; Neryl(S)-2-methylbutanoate; (R)-5-Methyl-2-(prop-1-en-2-yl)-hex-4-enyl acetate; (R)-lavandulyl acetate; 1,6,10-Dodecatriene, 7,11-dimethyl-3-methylene; (E)-beta-farnesene; 1,7-dioxaspiro (5.5) undecane; 1,5,7-Trioxaspiro[5.5]undecane; 9-tricosene; (-)-δ-Heptalactone; dihydro-beta-ionone; Methyl anthranilate; Cis-jasmone; Trans caryophyllene or mixtures thereof and,
at least one kairomone selected from the group consisting of Ethyl nicotinate; p-anisaldehyde; ethyl isonicotinate; (Z)-3-hexen-1-ol; α-pinene; (E)-β-caryophyllene; α-humulene; azulene; Trimedlure; methyl eugenol; Terpinyl acetate; acetate; Ginger Oil or mixtures thereof,
as the pest insect attractant, and,
at least one bio-insecticide acting by contact consisting of entomopathogenic fungus selected from the group consisting of the strains of Metarhizium anisopliae, Verticillium lecanii, Beauveria bassiana, Metarhizium brunneum, Isaria fumosorosea, Paecilomyces fumosoreuses, Beauveria brongniatii, or mixtures thereof,
said mixture being combined with (or comprising) at least one convenient inert carrier which has the property to allow said pest insect control formulation to adhere to the pest insect body and which is selected from the group consisting of kaolin, talc, bentonite, calcite, attapulgite, silica, aerosil, starch, stearic acid and stearates, corn flour, wheat flour, sugars such as fructose and glucose, or mixtures thereof, wherein said at least one pheromone, kairomone and bio-insecticide acting by contact is specific to said pest insect and wherein said pest insect species are selected from the group of insect orders consisting of Diptera, Homoptera, and Thysanoptera (Thripidae) such as Frankliniella occidentalis, (western flower thrips) or Hemiptera from the Aleyrodidae family (whiteflies family).

Preferably, the pest insect species are selected from the group of insect orders comprising or consisting of Diptera such as the suzuki-fruit fly (Drosophila suzukii), Thysanoptera (Thripidae) such as Frankliniella occidentalis, (western flower thrips) or Hemiptera from the Aleyrodidae family (whiteflies family) such as the Bemisia tabaci and Trialeurodes vaporariorum species.

Advantageously, the formulation of the invention containing an attractant specific for a targeted pest insect species and an entomopathogenic bio-insecticide is adapted to control pest insect populations such as Western Flower Thrip. By attracting the insect pest into a trapping device, loading it with the formulation of the invention and then, at exiting the trapping device, the insect will disseminate in the field where it will eventually die. Wherever some formulated material will have been distributed in the field, e. g. on plants, on the ground or on the remaining dead bodies of infected insects, further fellow creatures of the same species will be attracted and infected, thus multiplying the effect of the primary trapping device. The advantage is that the pest insect is used as the vector of its own demise, effectively using a minimal amount and limited applications of pesticides of biological origin.

Another object of the invention concerns a pest insect control method comprising or consisting in the steps of:
a) attracting a pest insect in a trapping device containing the pest insect control formulation according to the invention;
b) contaminating said pest insect with said pest insect control formulation according to the invention;
c) disseminating said contaminated pest insect into the field environment;
d) said disseminated and contaminated pest insect further attracting and contaminating other non-infected pest insects of the same species, wherein said pest insect species are selected from the group of insect orders consisting of Diptera; Homoptera and Thysanoptera (Thripidae) such as Frankliniella occidentalis, (western flower thrips) or Hemiptera from the Aleyrodidae family (whiteflies family).

Advantageously, the contaminated pest insect of step c) represents its own vector of contamination.

In other words, step d) above also refers to obtaining an attraction and a contamination of other non-infected pest insects of the same species by the disseminated and contaminated pest insect.

According to one embodiment of the invention, the method is adapted to control western flower thrips (Frankliniella occidentalis). Accordingly, the trapping device of step a) contains the pest insect control formulation specifically adapted to thrips and preferably to western flower thrips (Frankliniella occidentalis).

According to another specific embodiment of the invention, the pest insect control method is adapted to control the whitefly family and preferably the whitefly selected from the group of species consisting in Bemisia tabaci and Trialeurodes vaporariorum. Accordingly, the trapping device of step a) contains the pest insect control formulation specifically adapted the whitefly family selected from the species consisting in Bemisia tabaci and Trialeurodes vaporariorum.

According to yet another embodiment, the trapping device of step a) contains the pest insect control formulation adapted to control Drosophila suzukii. As described above, said pest insect control formulation consists in at least one pheromone which is Z)-9-tricosene, at least one kairomone which is methyl eugenol and at least one bio-insecticide acting by contact is Beauveria bassiana.

It is another object of the invention to provide for the use of the pest insect control formulation according to invention, in the pest insect control method of the invention.

To attract and control pest insects, a pest insect control formulation of the invention shall contain pheromones and kairomones that specifically attract the target insect species, and an insecticidal active substance, preferably a bio-pesticide on the basis of an entomopathogenic fungus. Upon entering a trapping device designed for this purpose, the target pest insect will come into contact with the formulation of the invention, a quantity of which will cover its body and will subsequently be carried away by the pest insect exiting the trap. While continuing its foray in the cropping environment, the contaminated insect will deposit some of the formulated material on the plants or on the ground so that its fellow creatures will in turn be attracted to it and contaminated by it. As long as the fungus will continue to multiply, the dead body of the carrying insect will also continue to act as an attracting and contaminating location in the field.

The pest insect attracts other pest insects of the same species and spreads the bio-pesticide on the basis of an entomopathogenic fungus. This is the big difference with the prior art. The pest insect cleaning itself deposits part of the powder (formulation of the invention) on the leaves or flowers which will attract other pest insects of the same population (species), but at the same time the pest insect will attract other pest insects of the same population with the part of the powder (formulation of the invention) that remains on its body and spread the entomopathogenic fungus. The innovation is also interesting in the fact that even after its death and thanks to the pheromone/Kairomone/entomopathogenic fungus mixture, the dead pest insect will continue to attract and spread the entomopathogenic fungus.

Thus, compared to the current state of the art of “attract and kill” systems, the pest insect control formulation of the invention, once disseminated in the field, will also attract further pest insects of the same species, thus multiplying the occurrence of contamination and improving the effectiveness of the insect control method. Using the pest insect itself as the vector of its own demise, no additional introduction of bumblebees or similar useful insects will be required.

The present invention may be used for numerous types of pest insects of the subfamily of thrips Thripinae, in particular Frankliniella occidentalis, the western flower thrips. Further Hemiptera order such as the Aleyrodidae families (white fly), or diptera such as Drosophila suzuki can also be treated with such formulation and method.

To be effective the bio-insecticide shall have a slow acting mode, giving time for the dissemination and recontamination process to take place. This is why it should preferably consist of conidia or spores of an entomopathogenic fungus. This has the additional advantage that the fungus may continue multiplying itself while being distributed in many places within the cropping field.

The pheromones and kairomones to be used as attractant will provide selectivity for the designated target insect. As an example of kairomones, p-anisaldehyde, ethyl nicotinate, or (S)-alkyl-2-methylbutyrates, alone or in mixture, can be used to attract western flower thrips.

The entomopathogen is selected from a group of fungus. Bioinsecticide already available on the market and with well-known modes of action may be used such as strains of Metarhizium anisopliae, Verticillium lecanii, Beauveria bassiana and Paecilomyces fumosoreuses.

The trapping device shall have a form and a surface texture adequate to delay the escape of the insect and to allow sufficient time for it to get loaded with the formulated material. Delta traps are preferred but other trap systems can also be used by the skilled in the art. Delta trap is a triangular trap, made of plastic or water-proof card. Insects that are attracted, depending upon the semiochemicals used, fly into the trap and will foray over a surface covered by the powder formulation of the invention but not, as it is common in such devices, stick to the surfaces, so that they will be able to escape this trapping device. Delta traps are common devices in the field of insect control. They are cost-effective and easy to assemble and use, enabling fast implementation.

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes which come within the meaning and range of equivalency are intended to be embraced therein.

Various references are cited throughout this specification, each of which is incorporated herein by reference in its entirety.

The foregoing description will be more fully understood with reference to the following Examples. Such Examples, are, however, exemplary of methods of practising the present invention and are not intended to limit the scope of the invention.

### EXAMPLES

Trials that were made with various inert materials, mixtures of semiochemicals, and entomopathogenic fungi delivered results that conform qualitatively the effectiveness of each step of the insect control process that forms the invention. They constitute a significant progress towards the verification of the whole concept of the invention.

### Selection of the Inert Ingredient:

Insects put in presence of a large amount of the powdery product must survive for a sufficiently long time to be able to get out of a trapping device and disseminate the product. The trapping device can be a delta trap or any other trapping device that would be convenient to the skilled person.

### Example 1: Assessment of Powder Adherence on Thrips Body

From 250 individual thrips (Frankliniella occidentalis) sourced from the company Bionema Limited in Swansea, 50 were released in mesh cages where fresh flowers and green beans were growing, and which contained a Petri dish filled with one powdery carriers. In those cages with talc and corn flour, the thrips loaded themselves within 15 min with enough powder to fully cover their body and remained capable of flying. In the cages with stearic acid, aerosil and fructose, the thrips stayed in contact with the powder for less than 3 minutes and died thereafter.

### Example 2: Survival in Presence of Inert Powder

Ten (10) individual thrips were deposited in Petri dishes whose bottoms were covered with corn flour or talcum powder at various rate. While immediately, the mobility of the insects was impaired in talcum powder, their survival in corn flour lasted as indicated in the following Table 2:

TABLE 2

| | | | | |
|---|---|---|---|---|
| Powder amount, grams | 0.05 | 0.10 | 0.15 | 0.20 |

Survival time over corn flour, hours

| | | | | |
|---|---|---|---|---|
| Coarse powder | 9 | 4 | 4 | 3 |
| Fine powder | 3.5 to 5.5 | 4.5 to 6.5 | 5.5 to 9.5 | 5.5 to 17 h |

### Conclusion:

The time during which an insect may support a powdery environment is sufficiently large to allow for a short permanence in a trapping device.

### Attractivity

The product must attract insects into the trapping device where they will get loaded with this powder.

A secondary attractivity must take place in the environment, caused by the amount of product that individual insects will have disseminated after having visited the trapping device.

### Example 3: Assessing Attractants

Talc and corn flour were either mixed with various concentrations of pheromone and kairomone, or an attracting lure was placed in the vicinity of the powder.

A 6-way olfactometer was used to assess the attractancy of thrips to the above treatment.

(Methods by George et al., Veterinary parasitology, volume 162, issue 1-2, 2009). Results are shown in Table 3.

TABLE 3

| Treatment | Attractants used | Concentration | Attractancy |
|---|---|---|---|
| High concentration | Pheromone | 0.2 mg/g powder | 100% |
| of a pheromone + | (neryl-(S)-2-methylbutyrate) | | |
| kairomone mix | p-anisaldehyde | 5 mg/g powder | |
| | Ethyl nicotinate | 5 mg/g powder | |
| Low concentration of | Pheromone | 0.05 mg/g | 95% |
| a pheromone + | (neryl-(S)-2-methylbutyrate) | | |
| kairomone mix | p-anisaldehyde | 2.5 mg/g powder | |
| | Ethyl nicotinate | 2.5 mg/g powder | |
| High concentration | Pheromone | 0.2 mg/g powder | 75% |
| pheromone only | of(neryl-(S)-2-methylbutyrate) | | |
| Low concentration of | Pheromone | 0.05 mg/g powder | 60% |
| pheromone only | (neryl-(S)-2-methylbutyrate) | | |
| Attractant lure | Pheromone + Kairomones | — | 90% |
| 5 cm above powder | (75 mg/g of a powder with a | | |
| | 50:50 composition of ethyl | | |
| | nicotinate and p-anisaldehyde) | | |

### Conclusion:

A multi-component or mix with pheromone and kairomones acts better than pheromone only. There was a high proportion of non-responding specimens, probably due to their developmental stage. This example also shows that the inert powder has no negative impact on the attractancy.

### Example 4: Assessing Attractivity in Open Environment

An attractant composed of a thrips specific pheromone (0.5% w/w in a 50/50 mixture of p-anisaldehyde and ethyl nicotinate) was dissolved in hexane and this solution was well mixed with corn flour. The mixture was subsequently left to dry at room temperature, and the powder was finely ground in a mortar.

Mixtures with two concentrations of the attractant were prepared with 1,0 and 1,33 cm3 per 100 g of flour.

Thrips were reared in an own rearing facility and collected from pepper, carnation and cucumber greenhouses at the 2nd and 3rd stages.

Small amounts of the powder were deposited on the bottom of delta traps. Sticky plates, as usually used in insect control, were affixed under the traps to catch insect that would approach them. These traps/sticky plate combinations were placed in enclosures into which thrips were introduced. After 24 hours, the sticky plates were collected, and the number of insects caught were counted. Results are shown in Table 4.

TABLE 4

| Treatment | Thrips caught on sticky plate | | |
|---|---|---|---|
| High concentration | 8 | 15.6 | 390% |
| High concentration | 18 | | |
| High concentration | 9 | | |
| High concentration | 28 | | |
| High concentration | 15 | | |
| Low concentration | 9 | 8.8 | 220% |
| Low concentration | 7 | | |
| Low concentration | 10 | | |
| Low concentration | 8 | | |
| Low concentration | 10 | | |
| Control, no attractant | 5 | 4 | 100% |
| Control, no attractant | 3 | | |

### Conclusion:

A first indication of the attracting sensitivity to the powder composition was demonstrated.

### Carrying Capacity of the Insect:

Once exposed to the product, the individual insect must carry a quantity of the material with it so that it can be disseminated in the environment.

### Example 5: Confirmation of the Ability of the Target Insect to Carry an Entomopathogenic Fungus

A Beauveria bassiana isolate (commercial product Naturalis ATCC 74040) was sprayed to wetness on filter paper disks (107 spores/ml) deposited in a Petri dish; a second Petri dish was connected to the first by a tube (length: 5 cm) in which the paper disk was wetted with a mix of pheromone and kairomone. Thrips (Frankliniella occidentalis) were introduced into this system. After two days, the paper disk of the second Petri dish was assessed for spores of B. Bassiana.

In 10 replications experiments the formation of B. Bassiana, colonies were observed in 5 cases, thus showing that the insect, after having been attracted and put in contact with the microorganism, did carry the entomopathogen to the second dish.

### Lethality:

The mode of action of the mycoinsecticide consists in penetrating into the insect body through its cuticle during the germination phase, and to multiply further while feeding and intoxicating the host insect. Once the host dead, the fungus continues to grow and forms a mycelium and spores around the dead body that will contaminate further insects as they will be attracted.

### Example 6: Lethality Assessment of Thrips Among Themselves

Thrips were loaded with a powder made of corn flour to which was added an attractant mixture similar to that of Experiment 4 at a rate of 1 and 1.3 ml per 100 g corn flour, and 0.12 g/100 g of the mycoinsecticide Botaniguard containing, according to its manufacturer, 4.4×10¹⁰ CFU/g (colony forming units per gram) of Beauveria bassiana.

5 (five) of these infested individuals together with 10 (ten) clean insects were introduced in jars closed with a fine mesh to keep the insects inside, the bottoms of which being covered with a paper filter and containing beans and honey as food for the insects. The temperature was kept at 24±1° C. and the relative humidity at >95%.

The dead insects were counted every day during seven days. Three replications were made.

Results are shown in Table 5.

TABLE 5

| | | | | | | | | | | | | | | | Total count | |
|---|---|---|---|---|---|---|---|---|---|---|---|---|---|---|---|---|
| Day Treatment | 1 | | 2 | | 3 | | 4 | | 5 | | 6 | | 7 | | Dead | Average |
| Control, no | 0 | 0 | 0 | 0 | 0 | 0 | 0 | 0 | 0 | 0 | 0 | 0 | 0 | 0 | 0 | 1.7 |
| infested insects | 0 | 0 | 0 | 0 | 1 | 0 | 0 | 0 | 0 | 0 | 0 | 0 | 0 | 2 | 3 | |
| | 0 | 0 | 0 | 0 | 0 | 1 | 0 | 0 | 0 | 0 | 0 | 0 | 1 | 0 | 2 | |
| High attractant | 0 | 0 | 0 | 0 | 1 | 4 | 3 | 2 | 0 | 2 | 0 | 2 | 2 | 0 | 15 | 14.7 |
| (1.33 ml/100 g) | 0 | 0 | 0 | 0 | 3 | 4 | 2 | 2 | 0 | 1 | 0 | 1 | 0 | 1 | 14 | |
| | 0 | 0 | 0 | 0 | 1 | 3 | 2 | 1 | 2 | 0 | 0 | 3 | 2 | 1 | 15 | |
| Low attractant | 0 | 0 | 0 | 0 | 2 | 0 | 1 | 0 | 4 | 1 | 2 | 3 | 2 | 0 | 15 | 14.3 |
| (1.0 ml/100 g) | 0 | 0 | 0 | 0 | 1 | 1 | 1 | 0 | 2 | 3 | 1 | 2 | 1 | 1 | 13 | |
| | 0 | 0 | 0 | 0 | 0 | 1 | 0 | 5 | 4 | 0 | 0 | 2 | 2 | 1 | 15 | |

### Conclusion:

Not only the individuals that had been infested with the mycoinsecticide did die but also almost all their clean congeners.

For verification, dead Thrips bodies were deposited in Petri dishes prepared with Sabord Dextrose Agar. The observed growth of fungal mycelium confirmed that the cause of death was associated with the mycoinsecticide.

### Example 7: Lethality Assessment of White Flies

Silverleaf whitefly (Bemisia tabaci) were loaded with a mixture of potato starch and an attractant mixture at a concentration of 1%, made of 52% (by weight) of Dihydro-beta-ionone, 40% (E)-2-Hexen-1-ol and 8% (E)-2-Hexanal, and 1.0 g/100 g of the mycoinsecticide Botaniguard containing, according to its manufacturer, 4.4×10¹⁰ CFU/g (colony forming units per gram) of Beauveria bassiana.

infested individuals were introduced together with 10 clean insects in jars closed with a fine mesh to keep the insects inside, the bottom pf which covered with a paper filter supporting leaves fragments of cucumber plants as food. The dead insects were counted after seven days. Results are shown in the table 6.

TABLE 6

Count

| Treatment | Dead | Average |
|---|---|---|
| Control: no infested insects | 4 | 4.3 |
| | 6 | |
| | 3 | |
| Treated: with infested insects | 12 | 13.0 |
| | 14 | |
| | 13 | |

Conclusion: similar to example 6, the mycoinsecticide carried by the treated individuals was transmitted to congeners and had its insecticidal effect.

### Example 8: Lethality Assessment of Spotted Wing Drosophila

In a similar way as in example 7, spotted wing drosophila (SWD, Drosophila suzukii) were loaded with a mixture of corn flour and an attractant mixture at a concentration of 1%, made of 50% (by weight) of (Z)-9-tricosene and 50% of methyl eugenol, and 1.0 g/100 g of the mycoinsecticide Botaniguard containing, according to its manufacturer, 4.4×10¹⁰ CFU/g (colony forming units per gram) of Beauveria bassiana.

individuals were loaded with this mixture and introduced together with 50 clean insects in jars closed with a fine mesh to keep the insects inside, the bottom pf which covered with a paper filter supporting large pieces of grated apple. The dead insects were counted after seven days. Results are shown in the table 7.

TABLE 7

Count

| Treatment | Dead | Average |
|---|---|---|
| Control: no infested insects | 12 | 15.0 |
| | 17 | |
| | 16 | |
| Treated: with infested insects | 43 | 47.3 |
| | 51 | |
| | 48 | |

Conclusion: similar to examples 6 and 7, the mycoinsecticide carried by the treated individuals was transmitted to congeners and had its insecticidal effect.

### General Conclusions:

In conclusion of this set of individual examples, each critical step of the concept has been tested with a positive result-inert carrier compatibility, attractiveness of a pheromone/kairomone mixture, carrying of the mycoinsecticide by the insect, lethality on secondary insects. Thus, the formal validity of the product concept has been demonstrated.

1. A pest insect control formulation in the form of a powder comprising the mixture of at least one pheromone and at least one kairomone as the pest insect attractant and at least one bio-insecticide acting by contact consisting of entomopathogenic fungus, the mixture being combined with at least one convenient inert carrier which has the property to allow the pest insect control formulation to adhere to the pest insect body and which is selected from the group consisting of kaolin, talc, bentonite, calcite, attapulgite, silica, aerosil, starch, stearic acid and stearates, corn flour, wheat flour, sugars such as fructose and glucose, or mixtures thereof, wherein the at least one pheromone, kairomone and bio-insecticide acting by contact is specific to the pest insect and wherein the pest insect species are selected from group of the insect orders consisting of Diptera, Homoptera, and Thysanoptera (Thripidae) such as Frankliniella occidentalis (western flower thrips) or Hemiptera from the Aleyrodidae family (whiteflies family).

2. The pest insect control formulation of claim 1, wherein the at least one pheromone is selected from the group consisting of Neryl-(S)-2-methylbutyrate; (S)-(Z)-3,7-Dimethyl-2,6-octadienyl-2-methylbutanoate; Neryl(S)-2-methylbutanoate; (R)-5-Methyl-2-(prop-1-en-2-yl)-hex-4-enyl acetate; (R)-lavandulyl acetate; 1,6,10-Dodecatriene, 7,11-dimethyl-3-methylene; (E)-beta-farnesene; 1,7-dioxaspiro (5.5) undecane; 1,5,7-Trioxaspiro[5.5]undecane; 9-tricosene; (-)-8-Heptalactone; dihydro-beta-ionone; Methyl anthranilate; Cis-jasmone; Trans caryophyllene or mixtures thereof.

3. The pest insect control formulation of claim 1, wherein the at least one kairomone is selected from the group consisting of Ethyl nicotinate; p-anisaldehyde; ethyl isonicotinate; (Z)-3-hexen-1-ol; α-pinene; (E)-β-caryophyllene; α-humulene; azulene; Trimedlure; methyl eugenol; Terpinyl acetate; acetate; Ginger Oil or mixtures thereof.

4. The pest insect control formulation of claim 1, wherein the at least one bio-insecticide acting by contact consists of entomopathogenic fungus which are selected from the group consisting of the strains of Metarhizium anisopliae, Verticillium lecanii, Beauveria bassiana, Metarhizium brunneum, Isaria fumosorosea, Paecilomyces fumosoreuses, Beauveria brongniatii, or mixtures thereof.

5. The pest insect control formulation according to claim 1, wherein the at least one pheromone is Neryl-(S)-2-methylbutyrate, the at least one kairomone is p-anisaldehyde or Ethyl nicotinate or a mixture thereof and the at least one bio-insecticide acting by contact is selected from the group consisting of Metarhizium anisopliae, Verticillium lecanii, Paecilomyces fumosoreuses, Beauveria bassiana, or a mixture thereof and wherein the pest insect is the western flower thrips (Frankliniella occidentalis).

6. The pest insect control formulation according to claim 1, wherein the at least one pheromone is dihydro-beta-ionone, the at least one kairomone is (E)-2-Hexanal or (E)-2-Hexen-1-ol or a mixture thereof and the at least one bio-insecticide acting by contact is selected from the group consisting of Metarhizium anisopliae, Verticillium lecanii, Beauveria bassiana, or a mixture thereof and wherein the pest insect is the whitefly selected from the species consisting in Bemisia tabaci and Trialeurodes vaporariorum.

7. A pest insect control method comprising the steps of:
a) attracting a pest insect in a trapping device containing the pest insect control formulation according to claim 1;
b) contaminating the said pest insect with the said-pest insect control formulation according to claim 1;
c) disseminating the contaminated pest insect into the field environment;
d) the disseminated and contaminated pest insect further attracting and contaminating other non-infected pest insects of the same species, wherein the pest insect species are selected from the group of insect orders consisting of Diptera; Homoptera and Thysanoptera (Thripidae) such as Frankliniella occidentalis (western flower thrips) or Hemiptera from the Aleyrodidae family (whiteflies family).

8. The pest insect control method according to claim 7, wherein the contaminated pest insect of step c) represents its own vector of contamination.

9. The pest insect control method according to claim 7, wherein the method is adapted to control western flower thrips (Frankliniella occidentalis).

10. The pest insect control method according to claim 9, wherein the at least one pheromone is Neryl-(S)-2-methylbutyrate, the at least one kairomone is p-anisaldehyde or Ethyl nicotinate or a mixture thereof and the at least one bio-insecticide acting by contact is selected from the group consisting of Metarhizium anisopliae, Verticillium lecanii, Paecilomyces fumosoreuses, Beauveria bassiana, or a mixture thereof and wherein the pest insect is the western flower thrips (Frankliniella occidentalis).

11. The pest insect control method according to claim 7, wherein the method is adapted to control the whitefly selected from the species consisting in Bemisia tabaci and Trialeurodes vaporariorum.

12. The pest insect control method according to claim 11, wherein the at least one pheromone is dihydro-beta-ionone, the at least one kairomone is (E)-2-Hexanal or (E)-2-Hexen-1-ol or a mixture thereof and the at least one bio-insecticide acting by contact is selected from the group consisting of Metarhizium anisopliae, Verticillium lecanii, Beauveria bassiana, or a mixture thereof and wherein the pest insect is the whitefly selected from the species consisting in Bemisia tabaci and Trialeurodes vaporariorum.

13. (canceled)

14. The pest insect control formulation according to claim 1, wherein the at least one pheromone is Z)-9-tricosene, the at least one kairomone is methyl eugenol and the at least one bio-insecticide acting by contact is Beauveria bassiana, wherein the pest insect is the Drosophila suzukii.

15. The pest insect control method according to claim 9, wherein the at least one pheromone is Z)-9-tricosene, the at least one kairomone is methyl eugenol and the at least one bio-insecticide acting by contact is Beauveria bassiana, wherein the pest insect is the Drosophila suzukii, and wherein the method is adapted to control Drosophila suzukii.
